(19) United States
(12) Patent Application Publication
(10) Pub. No.: US 2009/0130945 A1
(43) Pub. Date: May 21, 2009

(54) Children's toothbrush and aerial amusement device

(76) Inventor: David B. Moss, Allenhurst, NJ (US)

Correspondence Address: Steven Horowitz;Counselor at Law, Suite 700, 295 Madison Avenue, New York, NY, 10017, US

(21) Appl. No.: 11/986,464

(22) Filed: Nov. 21, 2007

(51) Int. Cl. A63H 33/00; A61C 17/00; B65D 81/36

(52) U.S. Cl. 446/76; 15/105; 446/71

(57) ABSTRACT

A toothbrush for children has a cape element extending from a point along its handle, the rigid cape element extending from the handle and adjoining the handle so as to divide the handle into a lower portion and an upper portion, the upper portion including a head having bristles. The handle and cape element define a space between them into which a child can place a hand to hold the toothbrush. The cape element meets the handle at a sufficiently large angle that a hand of a child on the lower portion of the handle can hold the lower portion and brush the child's teeth. The lower portion of the handle is smooth and not in contact with anything from a point on the lower portion just below where the cape element adjoins the handle and downward.

### BACKGROUND OF THE INVENTION

The present invention generally relates to apparatus and methods for encouraging children to brush teeth and, more particularly, to apparatus and methods of combining a children's toothbrush with an aerial amusement device.

Children need to learn to use toothbrushes to brush their teeth. Children's dental appointments can be expensive. The pain and fear they engender can also cause hysterical reactions in the children. Accordingly, anything that reduces cavities is helpful to the child and the child's parents. Brushing teeth is understood by the dental profession and public to reduce cavities in teeth. In addition, teaching children to brush their teeth helps to develop good habits for later use as adults.

As can be seen, there is a need for a toothbrush that encourages children to brush teeth.

### SUMMARY OF THE INVENTION

In one aspect of the present invention, there is presented a toothbrush and amusement device, comprising: a handle; a cape element extending from the handle and adjoining the handle so as to divide the handle into a lower portion and an upper portion, the upper portion including a head, the head having bristles extending therefrom, the handle and cape element defining a space between the handle and cape element into which a child can fit a hand positioned to grip the handle for brushing, the lower portion long enough so that the child can grip the handle for brushing teeth of the child.

In another aspect of the invention, there is presented a toothbrush and amusement device, comprising: a handle; a rigid flying object element extending from the handle and adjoining the handle so as to divide the handle into a lower portion and an upper portion, the upper portion including a head, the head having bristles extending therefrom, the handle and flying object element defining a space between the handle and cape element into which a child can place a hand to hold the toothbrush during brushing of the child's teeth, the flying object element meeting the handle at an angle exceeding approximately 30 degrees, the lower portion of the handle being tapered from a point on the lower portion just below where the flying object element adjoins the handle and downward.

In a further aspect of the invention, there is presented a lollipop and amusement device, comprising: a stick handle, a rigid cape element extending from the stick handle and adjoining the handle so as to divide the handle into a lower portion and an upper portion, the upper portion having a ball of candy attached to a top thereof, the stick handle and cape element defining a space between the stick handle and cape element into which a child can place a hand to hold the lollipop, the lower portion long enough to allow the child to hold the lollipop, the cape element meeting the stick handle at a sufficiently large angle that a hand of a child on the lower portion of the stick handle can hold the lower portion and lick the lollipop, the lower portion of the stick handle not in contact with anything from a point on the lower portion just below where the cape element adjoins the stick handle and downward.

In a further aspect of the invention, there is presented an amusement device, comprising: a utensil having a handle; a rigid cape element extending from the handle and adjoining the handle so as to divide the handle into a lower portion and an upper portion, the upper portion including a head, the head having bristles extending therefrom, the handle and cape element defining a space between the handle and cape element into which a child can fit a hand positioned to grip the handle for brushing of the child's teeth, the lower portion of the handle tapered from a point on the lower portion just below where the cape element adjoins the handle and downward, wherein the cape element has a shoulder, wherein the shoulder has an opening and wherein the handle fits into the opening in order to secure the cape element and handle to each other.

These and other features, aspects and advantages of the present invention will become better understood with reference to the following drawings, descriptions and claims.

### BRIEF DESCRIPTION OF THE DRAWINGS

FIG. 1 is a perspective view of the toothbrush according to one embodiment of the present invention;

FIG. 2 is a side view of the toothbrush of FIG. 1;

FIG. 3 is a front view of the toothbrush of FIG. 1;

FIG. 4 is a perspective view of the toothbrush according to a second embodiment of the present invention;

FIG. 5 is a side view of the toothbrush of FIG. 4;

FIG. 6 is a front view of the toothbrush of FIG. 4;

FIG. 7 is a perspective view of a child holding the toothbrush of FIG. 1 in the air as if it were a flying object;

FIG. 8 is a perspective view of a child holding the toothbrush of FIG. 1 and brushing with it;

FIG. 9 is a perspective view of an electric toothbrush for a child according to a third embodiment of the present invention;

FIG. 10 is a perspective view of a lollipop according t one embodiment of the present invention;

FIG. 11 is a side view of the lollipop of FIG. 10;

FIG. 12 is a front view of lollipop of FIG. 10;

FIG. 13 is a cross-sectional view of the brush of FIG. 4 showing a portion of the handle adjoining the cape element;

FIG. 14 is a bottom view of the brush of FIG. 4;

FIG. 15 is a side view of a toothbrush wherein the handle is adjoined to the cape element through an opening in the cape element; and

FIG. 16 is a top view of the cape element of the toothbrush of FIG. 15 from the rear wherein the cape element has a opening on the shoulder for adjoining to the handle.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a children's toothbrush that provokes a child into holding the brush and amusing himself or herself with it. Typically, the child may hold the brush at a lower portion of its handle and move it in the air as if it were a flying object. The cape element may suggest an action figure to the child or may remind the child of an action figure. Such an action figure may be a possible plastic figurine of a character from a movie, comic book, video game or television program. The fact that the child holds the brush and finds it appealing will increase the chance that the child will be willing to hold the brush to brush his or her teeth.

In contrast to the prior art, which discloses toothbrushes with amusing shapes and toothbrushes that are for amusement but are not practical to hold and brush with and do not simulate holding a regular (mechanical or electric) toothbrush, the toothbrush of the present invention can be used to pretend to fly with like an action figure yet at the same time the toothbrush of the present invention is comfortable for a child to grasp and hold for actual brushing since it contains a generally smooth lower portion of the handle. In further contrast to the prior art, where the interesting shapes jutting out of the brush interfere with the normal manner of holding the handle of the brush at its bottom portion, the toothbrush of the present invention has an amusing cape element that adjoins the handle of the brush at a location and angle that that does not interfere with a child holding the brush for actual brushing.

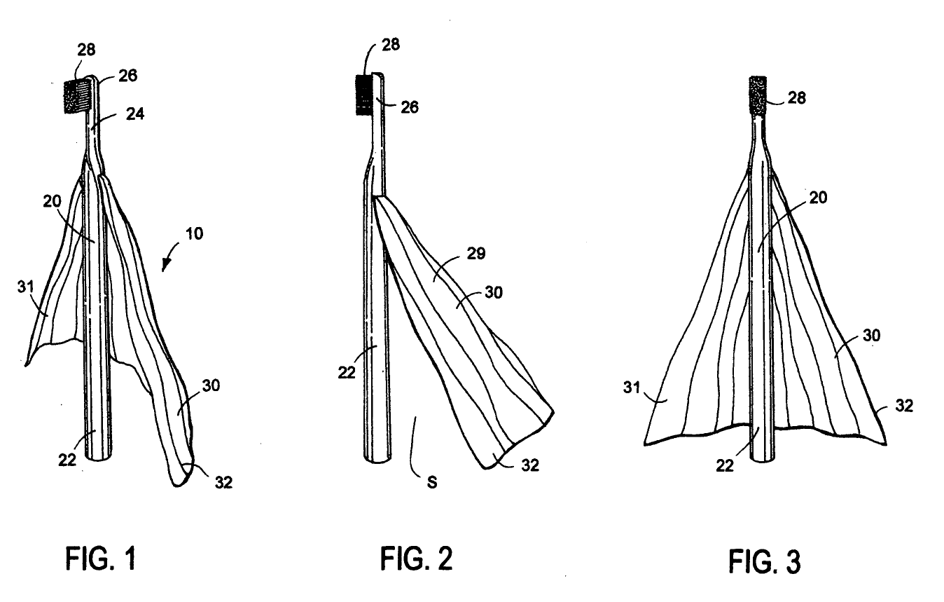

As seen from FIG. 1, brush 10 may include a handle 20 and a flying object element 29 such as a cape element 30. Cape element 30 may be any structural element that may look like or have the appearance of a “cape”, which is defined in Merriam Webster's Collegiate Dictionary (10^{th} ed.) as “a sleeveless outer garment or part of a garment that fits closely at the neck and hangs loosely over the shoulders”. Handle 20 should be comfortable for a child to grasp. Handle 20 may be an ordinary toothbrush handle. In some cases, lower portion 22 of handle 20 may be bereft of protrusions or shapes designed solely for amusement.

Flying object element 29 may take other forms besides cape element 30, for example wings (i.e. insect wings, fairy wings, to name a few examples) or a princess gown attached to handle 20. If instead of a cape element there were wings or another flying object element, the brush 10 would be identical except insofar as structural components unique to cape elements. For example, the discussion below with respect to the point where cape element 30 adjoins handle 20, its angle relative to handle 20, the existence of a space between cape element 30 and handle 20 for insertion of a hand of a child may also apply to another flying object element.

Cape element 30 may be integrally connected to handle 20, such as for example where cape element 30 and handle 20 are both made of rigid plastic. In other cases, cape element 30 may be a separate element that is attached to handle 20.

Cape element 30 may extend from handle 20 at a point high enough along handle 20 that a child can comfortably hold a lower portion of handle 20 in the normal manner that anyone brushing teeth holds a toothbrush. For example, cape element 30 may adjoin handle 20 approximately two-thirds of the way from the very bottom to the very top of brush 10. Cape element 30 may also adjoin handle 20 between approximately three-fifths to approximately four-fifths of the way from the very bottom of brush 10 to the very top of brush 10. In other cases, for example if upper portion 24 were lengthened relative to lower portion 22, cape element 30 may be positioned lower than two-thirds or lower than three-fifths of the length of the brush, but there may be sufficient room to insert a child's hand with room left over to adjust the grip of the child.

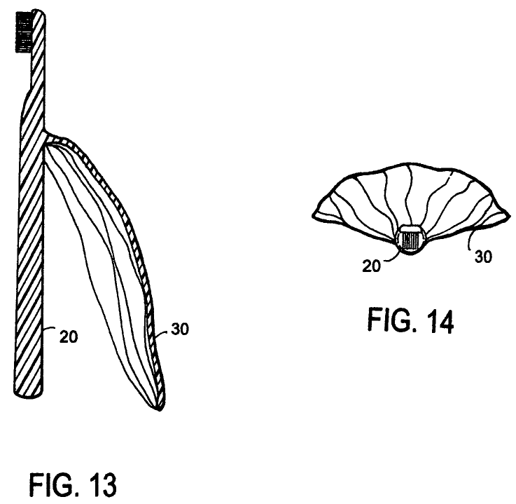

The area of contact between cape element 30 (or other flying object element 29) and handle 20 may be such as to provide stability and durability of brush 10. As such, cape element 30 (or other flying object element 29) may adjoin and be in contact with handle 20 along a relatively small distance of the length of handle 20. For additional stability, as seen from FIG. 13, cape element 30 (or other flying object element 29) may adjoin handle 20 at a portion of handle 20 lengthier than a mere point along handle 20.

In addition, for stability, as seen from FIG. 14, cape element 30 may adjoin and be in contact with handle 20 at a horizontal rotational portion/section of handle 20 of approximately 120 to approximately 150 degrees rotational arc of the surface of handle 20. Such point of horizontal rotational contact between cape element 30 and handle 20 may also be greater than approximately 150 degrees or less than approximately 120 degrees.

As seen from FIG. 2 and FIG. 5, cape element 30 may also be rigid enough so that cape element 30 may maintain a fixed position with respect to handle 20, at least until pressure is applied to cape element 30. Accordingly, cape element 30 may not droop or require flicking away or other effort by the child in order for the child to insert the child's hand in space S between cape element 30 and handle 20 to hold brush 10. The term “rigid” in this context does not preclude a gown that may be movable when force is exerted against it.

In an alternative embodiment, cape element 30 may be non-rigid, may droop and may require the child to first move cape element 30 prior to insertion of the child's hand on handle 20.

Cape element 30 may adjoin handle 20 and thereby divide handle 20 into a lower portion 22 of handle 20 and an upper portion of handle 20. Lower portion 22 and upper portion 24 are defined by reference to being below or above the point or the portion of the length of handle 20 that adjoins cape element 30. For definitional purposes, the portion or point of handle 20 along the length of handle 20 that is adjacent cape element 30 may be considered to be part of upper portion 24. Accordingly, lower portion 22 runs from the lower tip 23 of handle 20 to just below the portion of handle 20 that adjoins cape element 30. Upper portion 24 may also include a head 26 having bristles 28 extending from head 26.

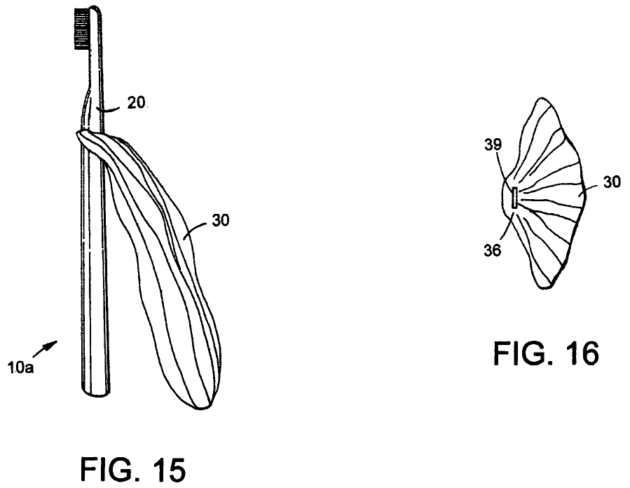

As seen from FIGS. 15-16, cape element 30 may adjoin handle 20 in ways other than those shown in FIGS. 1-6. For example, shoulder 36 of cape element 30 may have formed therein an aperture 39 of any suitable shape so as to removably receive handle 20 in a secure manner and allow cape element 30 to be adjoined to handle 20 at shoulder 36. In such a case, cape element 30 may be made of rubber which may be more flexible than plastic. Furthermore, this method of adjoining cape element 30 to handle 20 is designed to allow a utensil handle 20 (for example the handle of a toothbrush) to be fitted into the aperture by the user and to be removed by the user (i.e. a child or the child's parent) at the desire of the user. Depending upon the size of the aperture, handles of different utensils may be inserted into it. As a result, cape element 30 may be adjoined to different utensils besides a toothbrush, for example a pencil. As seen in FIG. 16, the aperture may be a slit opening 39 that may allow for a friction fit insertion of handle 20 of a utensil (i.e. a toothbrush) into cape element 30 at shoulder 36. The size of the opening 39 need not be rectangularly shaped and may be varied to correspond to a variety of handles for a variety of utensils. Besides friction fit, other methods of adjoining handle 20 to cape element 30 through opening 39 on cape element 30 may be used. In the top view of FIG. 16, the viewer is facing where the rear of brush 10a would be if it had been shown in that figure. In other embodiments.

As seen from FIG. 2 and FIG. 5, handle 20 and cape element 30 define a space S between them into which a child can place a hand to hold toothbrush 10. In addition lower portion 22 is long enough to allow the child to grip brush 10 for brushing. When speaking of a hand of a “child” in this context, the space S and length of lower portion 22 are such as to accommodate the hand of a child of any normal size and of an age up to approximately 10 years old.

In order to allow the child to grasp and hold brush 10 without discomfort, cape element 30 meets handle 20 at a sufficiently large angle that a hand of a child on the lower portion 22 of handle 20 can hold lower portion 22 and brush the child's teeth. Although cape element 30 need not be linear in cross-section or even substantially linear, it were it were linear, the angle that cape element 30 would need to meet handle 20 at so as to provide enough room for a child's hand may be approximately thirty-five degrees. Generally, the ideal angle may be between approximately thirty degrees and forty-five degrees, and more particularly between thirty-five degrees and approximately forty degrees. Since cape element 30 may not be linear, the angle would be measured by approximating the overall direction of cape element 30.

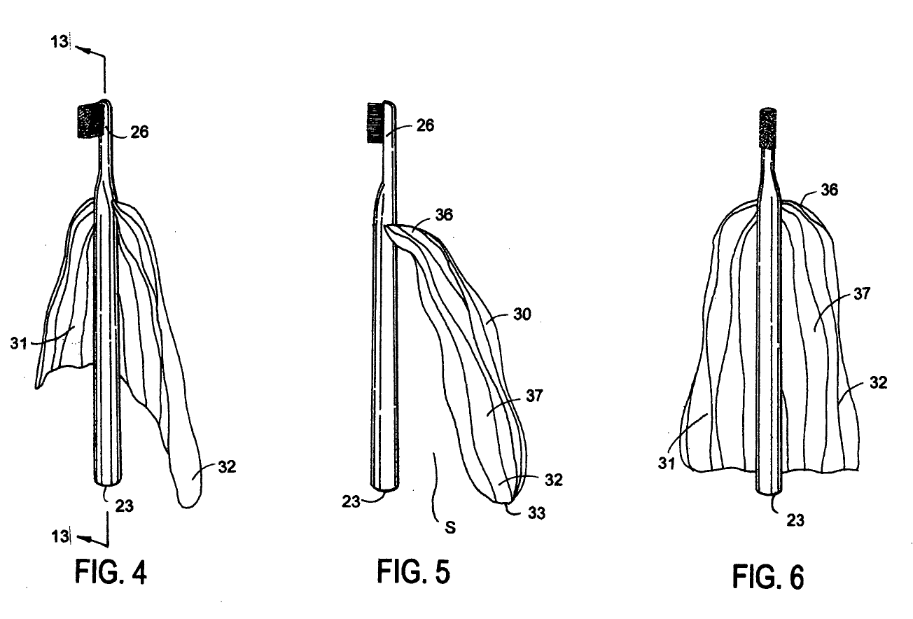

As shown in FIG. 3 and FIG. 6, cape element 30 has a left side 31 and a right side 32. As seen from FIG. 2 and FIG. 5, since left side 31 and right side 32 of cape element 30 may curved around toward handle 20. Left side 31 and right side 32 are sufficiently distanced, for example one inch or more, from lower portion 22 so that a child can easily insert his or her hand onto lower portion 22 of handle 20. Toothbrush may be dimensioned to be appealing to children of a variety of ages and sizes.

Lower portion 22 of handle 20 may be tapered so as to allow a child to comfortably grasp lower portion 22 during the child's brushing of the child's teeth. For the same reason, lower portion 22 of handle 20 may be smooth and shaped without elaborate projections from lower portion 22 that may render grasping by a child uncomfortable. Accordingly, lower portion 22 may be unconnected to (not in contact with) other structural elements, at least from a point on the lower portion just below where the cape element adjoins the handle and downward.

The length of lower portion 22 may vary, although given the typical width of a child's hand, and a need to have extra room for different grips, it is estimated that lower portion 22 may be approximately 3 to approximately 7 centimeters long.

Although FIG. 3 shows a lower tip of cape element 30 being roughly equal to a lowest tip of handle 20, cape element 30 may in fact extend lower, or in some cases higher, than handle 20. For example, as seen from FIG. 5, cape element 30 has a lower tip 33 that is lower than a lower tip 23 of handle 20.

FIG. 5 shows a brush 10 having a cape element 30 that extends outward before curving downward, thereby creating a shoulder 36. The remainder of cape element 30 below shoulder 36 may be referred to as the draping portion 37. Besides the fact that the presence of a shoulder 36 as part of cape element 30 serves to increase the suggestion of an action figure or of a human figure, shoulder 36 also makes it easier for the child to insert his or her hand. Shoulder 36 may be of varying widths to suggest different action figures.

Although the exact length and shape of cape element 30 may vary, cape element 30 may resemble a cape of an action figure or object so as to induce the child to grasp it and move it in the air like a flying object. Cape element 30 itself may take a number of shapes. As seen from FIGS. 1-6, cape element 30 may be shaped so as to appear “flowing”. As seen from FIG. 6, cape element 30 may be laterally symmetrical. As seen from FIGS. 10-12, cape element 30 of may also be shaped so as to appear robe-like. Although FIGS. 10-12 show a lollipop, the robe-like cape element 130 shown therein may in some case be used for cape element 30 of tooth brush 10.

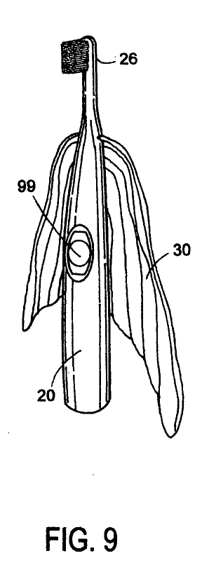

As seen from FIG. 9, toothbrush 10 may be any kind of toothbrush usable by a child, including an electric toothbrush having button 99 to activate head 36.

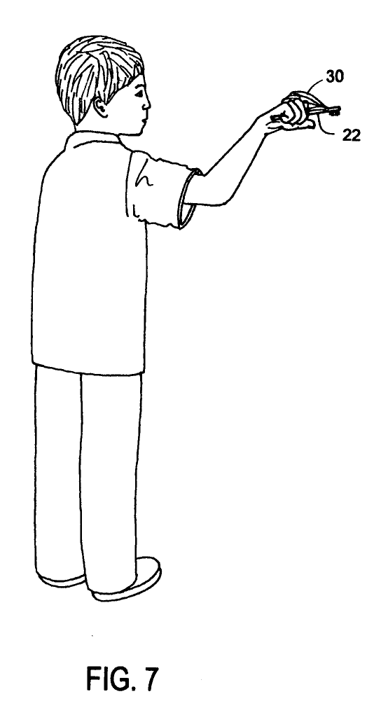

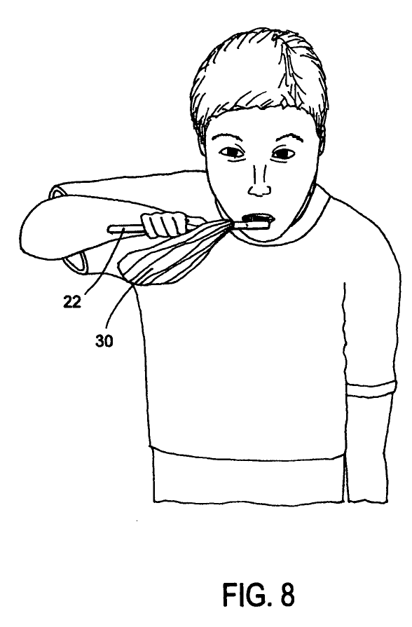

As seen from FIG. 7, which shows a child holding the toothbrush of FIG. 1 in the air as if it were a flying action figure or other object, a child can grasp lower portion 22 without cape element 30 obstructing the grip of the child. This is shown in FIG. 8 wherein the child's hand holds lower portion 22 of handle 20 while brushing with brush 10.

In another embodiment of the present invention, as seen from FIGS. 10-12, a lollipop and aerial amusement device 100 may include a handle 120 and a flying object element 129 such as a cape element 130. Flying object element 129 may also take other forms, such as wings attached to handle 120. The other elements of the toothbrush embodiment also apply to the lollipop embodiment.

For example, cape element 130 may be integrally connected to handle 120, such as for example where cape element 130 and stick handle 120 are both made of rigid plastic. In other cases, cape element 130 may be a separate element that is attached to handle 120.

Handle 120 may be a stick handle 120 similar to the type of stick typically found in a lollipop except that stick handle 120 may be made of plastic so as to be integrally connected to cape element 130. In other case, where stick handle 120 is not integrally connected to cape element 130, stick handle 120 may be made of the same material normally found in lollipops and cape element 130 may be connected to stick handle 120 by other means, such as adhesion via adhesive.

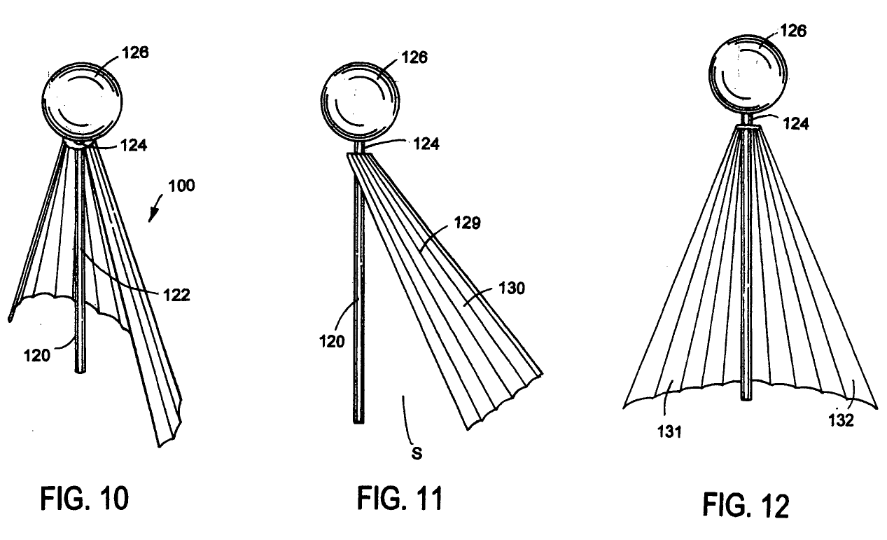

Cape element 130 may extend from stick handle 120 at a point high enough along stick handle 120 that a child can comfortably hold a lower portion of stick handle 120 in the normal manner that a child holds a lollipop. For example, cape element 130 may adjoin stick handle 120 approximately two-thirds of the way from the very bottom to the very top of lollipop 100. Cape element 130 may also adjoin stick handle 120 between approximately three-fifths to approximately four-fifths of the way from the very bottom of lollipop 100 to the very top of lollipop 100. As shown in FIGS. 11-12, cape element 130 may also adjoin stick handle 120 more than approximately 90% of the way from the very bottom to the very top of lollipop 100

Cape element 130 may adjoin handle 120 at a discrete point along the length of stick handle 20 or more likely for stability cape element 30 may adjoin stick handle 120 at a portion of stick handle 120 lengthier than a point along stick handle 120. In addition, as seen from FIG. 12, and since stability is harder to create when stick handle 120 is narrower than a toothbrush handle, cape element 130 may adjoin and be in contact with handle 120 at a full 360 degree rotational ring around the surface of handle 120.

With respect to lollipop 100, cape element 130 may also be rigid so that it does not droop or require flicking away or other effort by the child before insertion of the child's hand. Cape element 130 may adjoin handle 120 and thereby divide stick handle 120 into a lower portion 122 of handle 120 and an upper portion 124 of stick handle 120. Lower portion 122 and upper portion 124 are defined by reference to being below or above the portion or point of handle 120 that adjoins cape element 130. The portion or point of handle 120 that is adjacent cape element 130 may be considered to be part of upper portion 124. Upper portion 124 may also include a spherical candy head 126.

As seen from FIG. 12, cape element 130 may have a left side 131 and a right side 132. Left side 131 and right side 132 are sufficiently distanced, for example one inch or more, from lower portion 122 so that a child can easily insert his or her hand onto lower portion 122 of handle 120.

Stick handle 120 and cape element 130 define a space S between them into which a child can place a hand to hold lollipop 100.

In order to allow the child to grasp and hold lollipop 100 without discomfort, cape element 130 meets stick handle 120 at a sufficiently large angle that a stick hand of a child on the lower portion 122 of stick handle 120 can hold lower portion 122 and lick lollipop 100. Although cape element 130 need not be linear in cross-section or even substantially linear, it were it were linear, the angle that cape element 30 would need to meet handle 120 at so as to provide enough room for a child's hand may be approximately thirty-five degrees. Generally, the ideal angle may be between approximately thirty degrees and forty-five degrees, and more particularly between thirty-five degrees and approximately forty degrees. Since cape element 130 may not be linear, the angle would be measured by approximating the overall direction of cape element 130.

It should be understood, of course, that the foregoing relates to exemplary embodiments of the invention and that modifications may be made without departing from the spirit and scope of the invention as set forth in the following claims.

We claim:

1. A toothbrush and amusement device, comprising:
a handle;
a cape element extending from the handle and adjoining the handle so as to divide the handle into a lower portion and an upper portion, the upper portion including a head, the head having bristles extending therefrom,
the handle and cape element defining a space between the handle and cape element into which a child can fit a hand positioned to grip the handle for brushing, the lower portion long enough so that the child can grip the handle for brushing teeth of the child.

2. The toothbrush and amusement device of claim 1, wherein the lower portion of the handle is tapered.

3. The toothbrush and amusement device of claim 1, wherein the upper portion is at least 4 centimeters long.

4. The toothbrush and amusement device of claim 1, wherein the lower portion of the handle is a majority of a length of the handle and wherein the lower portion is smooth.

5. The toothbrush and amusement device of claim 1, wherein the lower portion of the handle is between approximately three-fifths and four fifths of a length of the handle.

6. The toothbrush and amusement device of claim 1, wherein the cape element is rigid.

7. The toothbrush and amusement device of claim 1, wherein the cape element suggests an action figure.

8. The toothbrush and amusement device of claim 1, wherein the cape element and handle are integrally connected.

9. A toothbrush and amusement device, comprising:
a handle;
a rigid flying object element extending from the handle and adjoining the handle so as to divide the handle into a lower portion and an upper portion, the upper portion including a head, the head having bristles extending therefrom,
the handle and flying object element defining a space between the handle and cape element into which a child can place a hand to hold the toothbrush during brushing of the child's teeth,
the flying object element meeting the handle at an angle exceeding approximately 30 degrees,
the lower portion of the handle being tapered from a point on the lower portion just below where the flying object element adjoins the handle and downward.

10. The toothbrush and amusement device of claim 9, wherein the upper portion is approximately 6 centimeters long.

11. The toothbrush and amusement device of claim 9, wherein the cape element has a left side and a right side and wherein the left and right sides are far enough away from the lower portion of the handle to permit entry of a child's hand into the space.

12. The toothbrush and amusement device of claim 9, wherein the cape element and handle are not integrally connected.

14. A lollipop and amusement device, comprising:
a stick handle,
a rigid cape element extending from the stick handle and adjoining the handle so as to divide the handle into a lower portion and an upper portion, the upper portion having a ball of candy attached to a top thereof,
the stick handle and cape element defining a space between the stick handle and cape element into which a child can place a hand to hold the lollipop, the lower portion long enough to allow the child to hold the lollipop,
the cape element meeting the stick handle at a sufficiently large angle that a hand of a child on the lower portion of the stick handle can hold the lower portion and lick the lollipop,
the lower portion of the stick handle not in contact with anything from a point on the lower portion just below where the cape element adjoins the stick handle and downward.

15. The lollipop and amusement device of claim 14, wherein the lower portion of the stick handle is smooth.

16. The lollipop and amusement device of claim 14, wherein the lower portion represents more than approximately ninety percent of a length of the stick handle of the lollipop.

17. The lollipop and amusement device of claim 14, wherein the cape element suggests an action figure.

18. The lollipop and amusement device of claim 14, wherein the cape element and handle are integrally connected.

19. An amusement device, comprising:
a utensil having a handle;
a rigid cape element extending from the handle and adjoining the handle so as to divide the handle into a lower portion and an upper portion, the upper portion including a head, the head having bristles extending therefrom,
the handle and cape element defining a space between the handle and cape element into which a child can fit a hand positioned to grip the handle for brushing of the child's teeth,
the lower portion of the handle tapered from a point on the lower portion just below where the cape element adjoins the handle and downward,
wherein the cape element has a shoulder, wherein the shoulder has an opening and wherein the handle fits into the opening in order to secure the cape element and handle to each other.

20. The amusement device of claim 19, wherein the handle fits into the opening by means of a friction fit and wherein the handle can be removed from the cape element by a user.
